(19) United States
(12) Patent Application Publication
(10) Pub. No.: US 2014/0188575 A1
(43) Pub. Date: Jul. 3, 2014

(54) COLLABORATIVE QUALITY ASSURANCE SYSTEM AND METHOD

(71) Applicant: Laureate Education, Inc., Baltimore, MD (US)

(72) Inventors: HEATHER WELZANT, Gambrills, MD (US); Patricia Ryan, Baltimore, MD (US); Jo Ann Emenecker, Linthicum, MD (US)

(73) Assignee: Laureate Education, Inc., Baltimore, MD (US)

(21) Appl. No.: 14/145,342

(22) Filed: Dec. 31, 2013

Related U.S. Application Data
(60) Provisional application No. 61/747,946, filed on Dec. 31, 2012.

(51) Int. Cl. G06Q 50/20; G06Q 10/06

(52) U.S. Cl. CPC G06Q 50/205; G06Q 10/06393
USPC 705/7.39

(57) ABSTRACT

The system and method for quality assurance (QA) of educational institutions, programs, courses, services, and processes stores a QA framework associated with an educational QA review in a database. The QA framework comprises one or more Quality Components (QCs) such that each QC is associated with one or more Quality Indicators (QI). Each QI is defined as a statement related to an educational quality attribute. A QI evaluation template is presented to one or more QA reviewers over a network for evaluating each QI. The QI evaluation template is used by the one or more QA reviewers for entry of one or more Observation Information (OI) for a QI under evaluation and associating each OI with respective evidence information and recommendation information (RI). The RI is then prioritized based on one or more evaluative metrics.

### CROSS-REFERENCE TO RELATED APPLICATION

This application is related to and claims priority to U.S. Provisional patent application No. 61/747,946, filed Dec. 31, 2012, the specification of which is hereby incorporated by reference in its entirety.

### BACKGROUND OF THE INVENTION

1. Field of Invention

The present invention relates generally to a system and method for quality assurance (QA) of educational institutions, programs, courses, services, and processes, and more specifically to a system and method of QA reviews through an online collaboration environment.

2. Description of Related Art

Laureate Education, Inc., the assignee of the present application, is a global provider of high-quality education that serves more than 75 accredited campus-based and online post-secondary institutions and nearly 800,000 students in over 30 countries. It is known that effective delivery of educational programs to such diverse student bodies requires quality criteria and standards that respond to the global demand for greater accountability to ensure the soundness of academic and organizational effectiveness. Overcoming challenges in education is best achieved by proactively implementing QA processes.

The Alfred P. Sloan Foundation has played an important role in the development of online learning in American higher education. One significant initiative of the Foundation has been the establishment of the Sloan Consortium of Colleges and Universities, which is known as Sloan-C. Sloan-C is a “professional online learning society devoted to advancing quality e-Education learning into the mainstream of education through its community” (The Sloan Consortium, 2013). Sloan-C provides access to high quality e-Education to individuals, institutions, professional societies, and the corporate community. Sloan-C has evolved into an institutional and professional leadership organization dedicated to integrating online education into the mainstream of higher education, helping institutions and individual educators improve the quality, scale, and breadth of online education. Sloan-C provides a full range of member services including annual conferences, professional development webinars, publishing the Journal of Asynchronous Learning Networks, and sponsoring research initiatives. Sloan-C also offers an interactive scorecard which measures and quantifies elements of quality of online higher education programs. Administrators use the interactive scorecard tool for program evaluation. By conducting an analysis of each of the quality indicators (QIs) within the categories, an evaluator is able to determine strengths and weaknesses of their program. Sloan-C interactive scorecard is a tool that can identify weaknesses to support program improvement and planning. The evaluator only examines programs for alignment of evidence with the QIs and the evaluator assigns a score based on the observations and evidence (The Sloan Consortium, 2013).

Quality Matters (QM) is a leader in QA for online education and has received national recognition for its peer-based approach to continuous improvement in online education and student learning. The program features faculty-centered, continuous improvement models for assuring the quality of online courses through peer review and professional development workshops and certification courses for instructors and online learning professionals, as well as rubrics for applying quality standards to course design. QM subscribers include community and technical colleges, colleges and universities, K-12 schools and systems, government agencies, corporations, and other education-related organizations.

The Baldrige Program oversees the nation's only Presidential award for performance excellence while offering criteria, assessments, tools, training, and a community for those dedicated to helping organizations improve. “The Baldrige Education Criteria for Performance Excellence requirements are embodied in seven integrated, interconnected categories, namely: 1) Leadership, 2) Strategic Planning, 3) Customer Focus, 4) Measurement, Analysis, and Knowledge Management 5) Workforce Focus, 6) Operations Focus and 7) Results. Responses to Education Criteria items are scored on two evaluation dimensions: process and results” (The National Institute of Standards and Technology (NIST), Baldrige Performance Excellence Program, 2013).

Capability Maturity Model Integration (CMMI) is a collection of model components, training material components and an appraisal component. CMMI is administered and marketed by Carnegie Mellon University and required by many Department of Defense and U.S. Government contracts, especially software development. CMMI can be used to guide process improvement across a project, division, or an entire organization. Under the CMMI methodology, processes are rated according to their maturity levels, which are defined as: Initial, Repeatable, Defined, Quantitatively Managed, Optimizing (Carnegie Mellon University, 2013).

Given the complex nature of providing quality education on a global platform, there exists a need for a scalable quality assurance system to strengthen assessment, accountability, and continuous monitoring and improvement of academic and organizational effectiveness.

### SUMMARY OF THE INVENTION

Briefly according to the present invention, the system and method for quality assurance (QA) of educational institutions, programs, courses, services, and processes stores a QA framework associated with an educational QA review in a database. The QA framework comprises one or more Quality Components (QCs) such that each QC is associated with one or more Quality Indicators (QI). Each QI is defined as a statement related to an educational quality attribute. A QI evaluation template is presented to one or more QA reviewers over a network for evaluating each QI. The QI evaluation template is used by the one or more QA reviewers for entry of one or more Observation Information (OI) for a QI under evaluation and associating each OI with respective evidence information and recommendation information (RI). The RI is then prioritized based on one or more evaluative metrics.

According to some of the more detailed features of the present invention, the one or more evaluative metrics can be either qualitative or quantitative evaluative metrics, or both. In one embodiment, the one or more quantitative evaluative metrics are calculated for each QI based on scores entered by the one or more QA reviewers.

According to other more detailed features of the present invention, the evidence information associated with each OI is associated with one or more files. The one or more files are linked to the QI under evaluation via a QA Workbook stored in the database. Each QC is defined based on at least one Quality Theme associated with an educational quality attribute and at least one Quality Consideration framed as a question related to the at least one Quality Theme.

According to still other more detailed features of the present invention, a QI tasking diagram is presented to the one or more QA reviewers specifying actions for evaluation of each QI. The QA review statuses can be monitored. QI data can be analyzed for tracking quality attributes over time. A template that allows a QA reviewer to schedule a due date for the QA review can be presented as well as a template that allows a QA reviewer to send notifications to one or more QA participants.

### BRIEF DESCRIPTION OF THE DRAWINGS

FIG. 1 shows an exemplary block diagram of the collaborative Quality Assurance System (QAS) 100, according to one embodiment of the invention.

FIG. 2 shows a functional block diagram of a QA review process implemented in the QAS 100 of FIG. 1.

FIG. 3 shows quality components (QCs) and QIs for an institutional QA review.

FIG. 4 shows QI tasking for the institutional QA review.

FIG. 5 shows the course QA framework with QCs and QIs for a course QA review.

FIG. 6 shows QI tasking for the course QA review.

FIG. 7 shows a user interface for selecting a QC of a QA framework to review and submit observations, evidence, and recommendations.

FIG. 8 shows a user interface for entering observations, evidence, and recommendations for each QI.

FIGS. 9a-9c show an interface by which QA reviewers apply quantitative ratings to the QIs.

FIG. 10 shows a QA Index (QAI) module that calculates scores for each QI.

FIG. 11 shows calculation functions of the QAI module.

FIG. 12 shows an example of a reporting web page interface.

FIG. 13 shows an interface for presenting sample summary of a QA rating performance.

FIG. 14 shows an interface for presenting QA review results with scores and comments from the QA reviewer and QA review manager.

FIG. 15 shows an interface presenting the status of activities for QA reviews.

FIG. 16 shows the status activity for the review of all the Themes and Considerations of the course QA review.

FIG. 17 shows a notification template.

### DETAILED DESCRIPTION

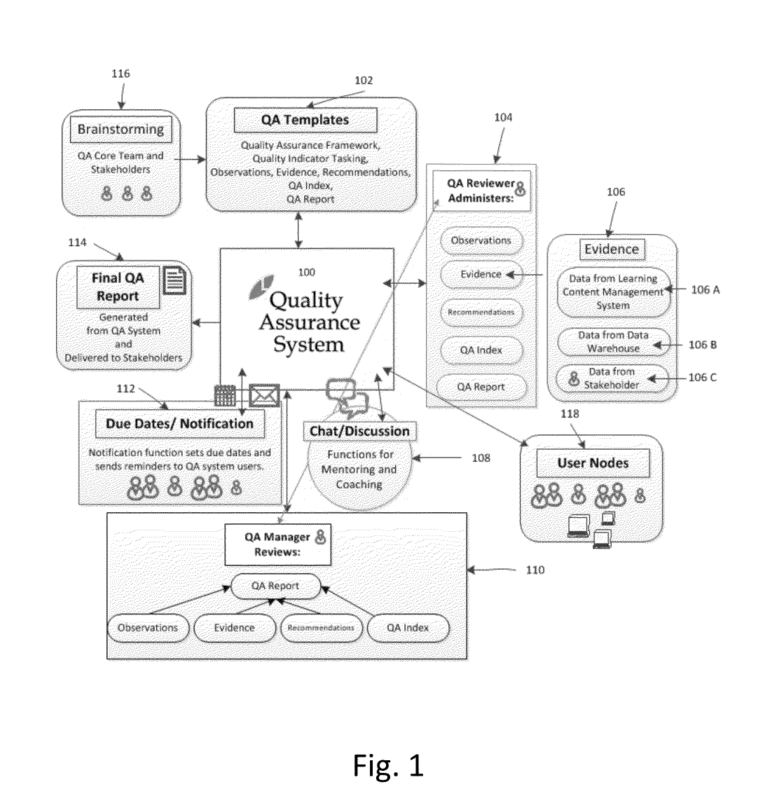

FIG. 1 depicts an exemplary block diagram of a collaborative QAS 100 according to an exemplary embodiment of the present invention. The information provided to the QAS 100 are based on QA reviews, which comprise an evaluative case study for any institution, program, course, service, or process for any quality assurance initiative in education. The QA reviews can be applied to:

Institutional reviews, which focus on an entire institution in a comprehensive manner.

Program reviews, which focus on one program within an institution, such as a specific bachelor, master, or doctoral program.

Course reviews, which focus on one course within an institution, within a bachelor, masters, or doctoral program.

Service reviews, which focus on one service area within an institution, such as student services, disability services, or registrar services.

Other reviews, which may be customized for specialized areas, such as policies, procedures, and practices.

The specific goals of the QA reviews are to:
1. Ensure that products and services reflect institutional values, mission, and expectations of quality;
2. Identify strengths and consistency in products and services;
3. Provide evidence that products and services are being implemented to maximize student learning, stimulate student motivation, and facilitate student retention; and
4. Provide recommendations for enhancing products and services.

Thus, the QAS 100 can be used to conduct collaborative QA reviews for institutions, programs, courses, services and other customized QA reviews using specific criteria in a QA framework. The QA framework consists of clearly defined QCs, with each component being associated with corresponding QIs, which are statements of quality. In one embodiment, the QCs originate from brainstorming of quality themes (Themes) associated with educational quality attributes and quality considerations (Considerations) amongst QA core team members and stakeholders. The Themes are any aspect of an educational product, service, or process with educational quality attributes. The Considerations are framed as questions related to the Themes. Once QA core team members brainstorm the Themes and Considerations, QA reviewers use the Themes and Considerations to create the QA framework. The QA framework consists of broad QCs specifically defined with accompanying QIs. The QIs are quality statements related to educational quality attributes that are aligned or otherwise associated with the QCs. Accordingly, the QA framework is a tool for a consistent and systematic approach to assessing quality. Once the QA framework is defined, developed, and approved, QA reviewers assess each QI with defined qualitative and quantitative evaluative metrics. The qualitative and quantitative evaluative metrics are used to associate each QI with prioritized Recommendations Information (RI) based on Observation Information (OI) and Evidence Information.

The QAS 100 of the present invention engages various participants, such as QA reviewers, stakeholders, QA core team members, and QA managers. The QAS 100 can be implemented using any type of mass collaboration system, including chat, e-mail messaging, and discussion boards as well as interactive tools for posting content to be shared by groups of QA participants assigned to corresponding QA projects. The QAS 100 executes suitable applications for providing one or more collaborative QA environments during which the QA core team, QA reviewers, and QA stakeholders can work collaboratively on QA initiatives that are tailor-made for any number of applications, some examples of which are described below. The QAS 100 provides the necessary user interfaces for the QA core team members, QA reviewers, and other QA stakeholders to communicate with one another; for example, allowing the QA core team members to interact with and monitor QA reviewer activities.

A plurality of nodes are connected to the QAS 100. They comprise one or more QA reviewer/administrators node 104, QA core team member/stakeholder node 116, QA manager node 110, and users nodes 118. The user nodes 118 are used by the participants involved in the collaborative QA process, such as students, instructors/teachers/faculty, resource managers, etc., who are registered within the QAS 100. According to the exemplary embodiment of FIG. 1, a user node can be used by an individual user 118 for connecting to the network over any type of communication link.

The QAS 100 provides interfaces for participants to log in with a user ID and password. Based on the access privilege associated with the user ID, the QAS 100 may authenticate the participant as a QA core team member, an administrator or a reviewer, stakeholder, etc. In one embodiment, a discussion board 108 for dialogue and discussion among the various QA reviewers is provided as a mechanism for multi-tiered coaching and mentoring. This gives QA reviewers and QA leadership an opportunity to have an overarching preview with a feature to provide feedback. The discussion board is used to provide mentoring, coaching, and feedback at multiple levels throughout the QA review process.

In one embodiment, the QAS 100 provides a centralized digital, cloud solution for accessing one or more databases 106, containing a variety of data 106A-C as well as a database 102, which among other things contains QA templates. These databases contain documentation workbooks, files (e.g., audio, video, image), and templates and data from stakeholders associated with QA reviews. In one embodiment, the QA reviewers are responsible for developing content used in the QA process of the invention, including QA templates and other material as further described below. According to one embodiment, evidence is electronically pulled from a learning management system 106 A and data warehouse 106 and imported into the QAS 100 through a network, such as any type of Intranet or the Internet. The one or more databases can contain QA reviewer input as well as templates relating to rankings, pre-defined QA criteria in a QAI, and QA results and QA reports as further described below. The QAS 100 uses a common template for each type of review; however, it is customizable depending upon the unit under review.

The QAS 100 synchronizes the information stored in databases with centers 106 A-C. In this way, the QA reviewers use the user nodes 118 to hold online collaboration sessions remotely from their user devices, including but not limited to other public areas, without having to attend in-center QA sessions. Through the collaborative QA environment created by the system and method of the present invention, team members can assign tasks to other stakeholders enrolled in the QA process, monitor the reviewer's progress, and interface with the reviewer through interactive communication channels that communicate documents, audio, video, text, images, etc., in real time or non-real time modes.

In one embodiment, access to QA data is provided through a web-based centralized data repository within the one or more databases 106 A-C. The databases include interactive observations and comments feature where multiple QA reviewers can enter information regarding observations. The system includes data and project management components through a website with a graphical user interface. A Due Dates/Notification node 112 provides the QAS 100 with information for tracking the core team and QA reviewers' scheduling, activities, progress, etc. A QA Report node 114 generates QA reports based on information provided by the QAS 100.

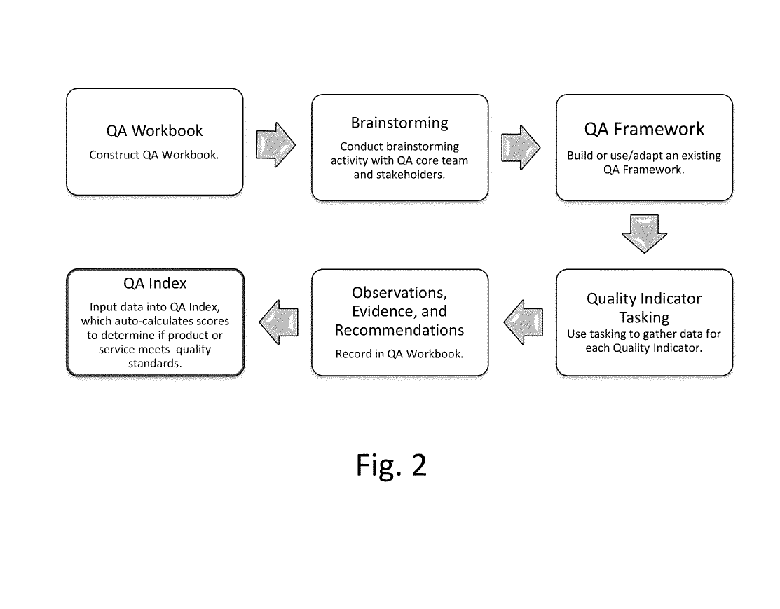

FIG. 2 shows a functional block diagram of the QA review process, which involves construction of a QA Workbook that is stored in a database. All essential elements of the QA process are documented, stored, analyzed, and contained within the QA Workbook. The QA Workbook also contains all elements of the QA frameworks, namely, defined QCs and associated QIs. In this way, QA reviewers can search for the QCs of the QA framework as it is necessary to bring the items into the QA review documentation, allowing the QA reviewers to have access to consistent observations/recommendations per QIs. Version control is implemented when multiple participants collaborate on the QA Workbook. In one embodiment, one version of the QA Workbook is editable and other versions are not editable. A QA lead reviewer can put content in the final version, or collaboratively edit the final document.

The collaborative QA review process further involves gathering information by QA reviewers, for example, by conducting brainstorming activities with core team members to develop QCs used to build the QA framework. Such members can be students, instructors, faculty, administrators, resource or service managers, etc. More specifically, the core team can identify to QA reviewers information relating to the institutions, programs, courses, services, and processes that are subject to quality assurance. The identified Themes and Considerations are represented in terms of the QA framework, which includes QC information that relates to any aspect of the institutions, programs, courses, services, and processes. As stated above, each QC is associated with one or more QIs. A QI comprises a statement of quality that can be measured based on objective or subjective criteria. As such, each QI is an educational quality attribute statement that is correlated with a corresponding QC.

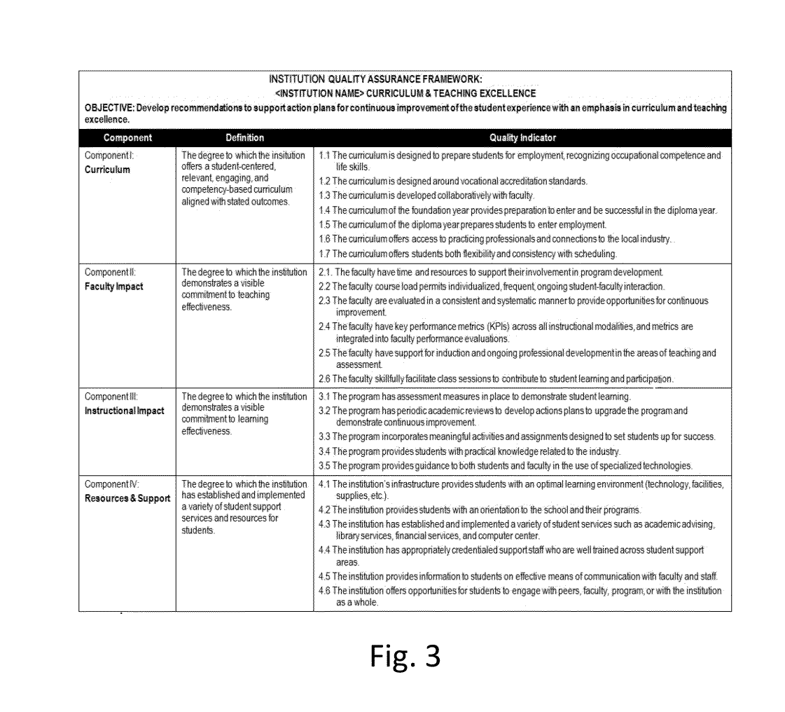

The following describes two examples of QA reviews applied to a technical institute outside of the United States (the institutional QA review) and a course (the course QA review). FIG. 3 shows the QA framework for the institutional QA review stored on a database. The institutional QA review assesses the quality of the student experience in four QCs: 1) curriculum, 2) instructor impact, 3) instructional impact, and 4) resources and support. The institutional QA framework of FIG. 3 shows QCs of the institutional QA review as QC (QC-1, QC-2, QC-3, and QC-4), which are part of the institutional QA framework with specifically defined QC information. The middle column in FIG. 3 shows definitions that are associated with each QC. These definitions can be derived from quality Themes associated with educational quality attributed and quality Considerations framed as questions related to the Themes.

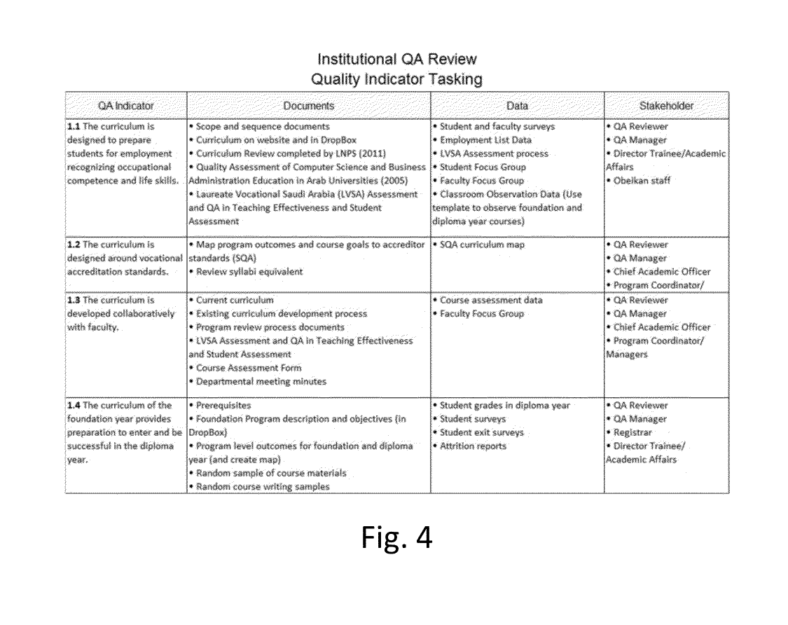

The QA review under the present invention requires each QI associated with each QC to be evaluated. In one embodiment, QI tasking is used for evaluating each QI by gathering observation information for each QI. Such data are entered into the QA Workbook by QA reviewers. For the institutional QA review, FIG. 4 shows QI tasking of a sampling of the four (4) QIs associated with QC-1 Each QI of the institutional QA review is evaluated based on a set of tasks performed by QA reviewers; for example, review of documents and data, conducting observations and interviews, as well as research, etc.

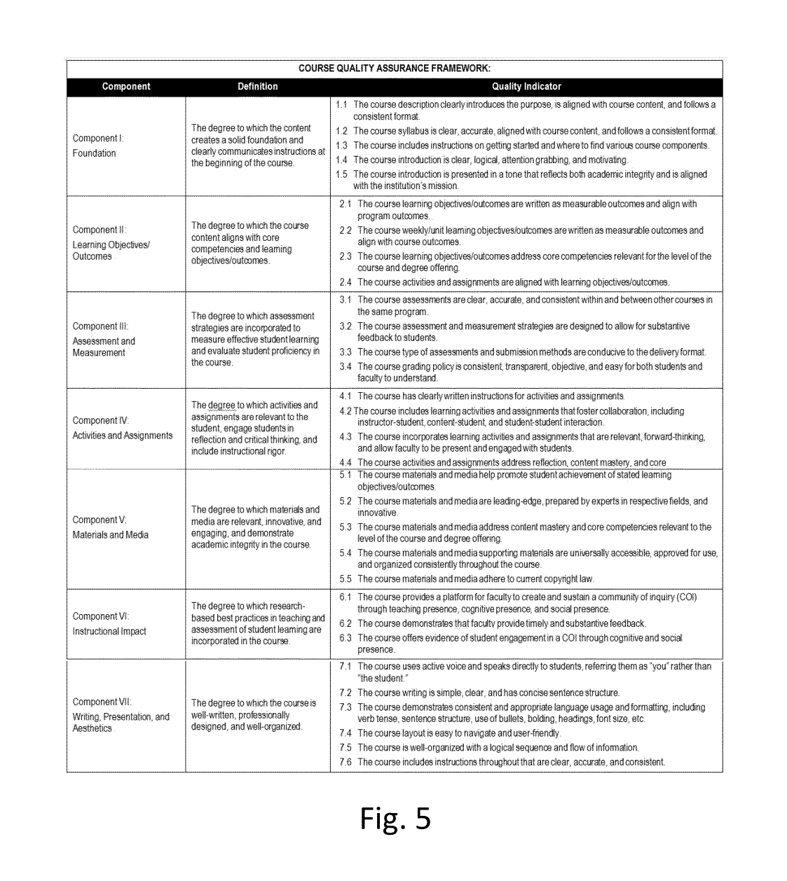

FIG. 5 shows the QA framework stored on a database for the course QA review. As shown, QC-1, QC-2, QC-3, QC-4, QC-5, QC-6, and QC-7 are part of the course QA framework with specifically defined QC information. The middle column in FIG. 5 shows definitions that are associated with each QC.

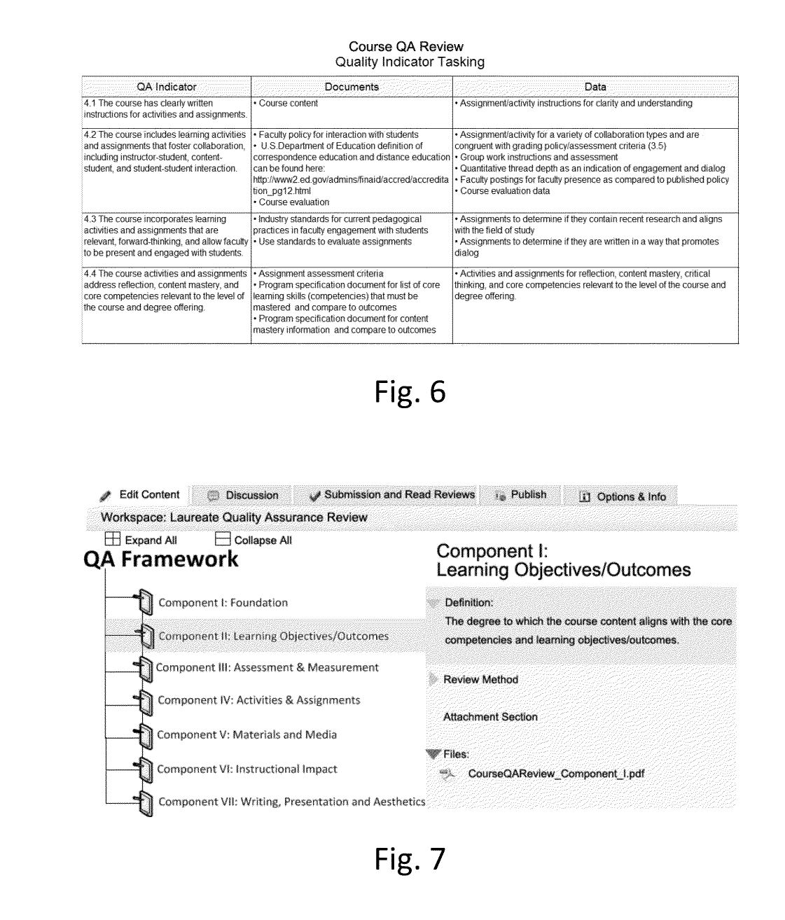

FIG. 6 shows a QI tasking diagram for QIs of the course QA review. The QI tasking identifies specific actions for the QA reviewer to take to ensure that each QI is thoroughly evaluated. For the course QA review, FIG. 6 shows QI tasking of a sample of four (4) QIs associated with QC-1, and the documents and data that are gathered and analyzed to support the QA review of those QA indicators.

FIG. 7 shows a user interface presented by QAS 100 for selecting a QC of a QA framework to review and submit observations, evidence, and recommendations for the associated QIs along with supporting documentation and files, which are stored in the databases.

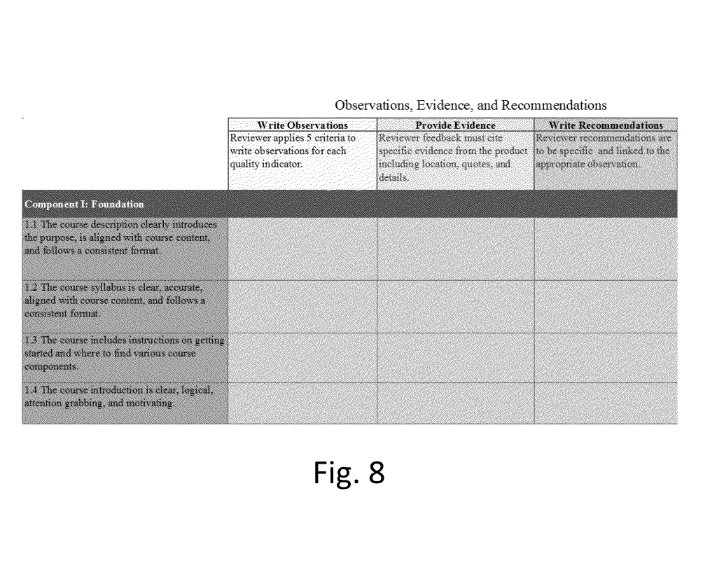

FIG. 8 shows a user interface presenting a QI evaluation template for entering Observation Information (OI), Recommendation Information (RI) and Evidence Information for each QI. As such, the QI evaluation template is used by the QA reviewers for entry of OI for the QI under evaluation and associating each OI with respective evidence information and recommendation information.

The OI is entered based one or more predefined observation criteria. In one embodiment, the QA reviewers apply five criteria when gathering and entering observational information into the system:
1. Constructive: offer solutions, not just identify problems
2. Specific: include specific example of what is being recommended
3. Measurable: be measurable and indicate an action that can be observed
4. Sensitive: avoid negative language and keep recommendations and comments positive
5. Balanced: point out strengths as well as weaknesses

For example, for QI-1 of QC-1 of the institutional QA review, the following OI is entered into the QI evaluation template by applying the above criteria.

| QUALITY | | | |
|---|---|---|---|
| INDICATORS | | OBSERVATIONS | |
| # | DESCRIPTION | # | DESCRIPTION |
| 1.1 | The curriculum is | 1 | Students are unaware of criteria, interest |
| | designed to prepare | | inventories, or assessments used to place |
| | students for | | them in specific programs. |
| | employment, | 2 | Instructors express concem about trainee |
| | recognizing | | entry-level English Skills. |
| | occupational | 3 | Life skills, other than English, were not |
| | competence and life | | evident in curriculum documents. |
| | skills. | | |

For each observation, QA reviewers enter specific supporting evidence information into the QI evaluation template that identifies the evidence source for access if necessary. For example, such evidence could be supported by stakeholder focus groups or interviews or evidence documents or other material, e.g., audio, video, etc., which are linked to corresponding OIs of each OI in the database. QA reviewers also enter and associate RI that are specifically linked to each OI. In this way, the recommendations are derived from evidence-based observations.

Recommendation Information are prioritized based on evaluative metrics to provide specific suggestions for actions. The RIs can be prioritized based on qualitative or quantitative evaluative metrics, or a combination of both. In the above institutional QA review example, RI for modifications can be classified at one level based on qualitative evaluative metrics as:
a) Substantive (S): relating directly to student learning, including curriculum, instruction, and assessment, or
b) Technical (T): involving areas such as resources, services, and facilities.

Within the S and T categories, RIs can be further classified at another level based on qualitative evaluative metrics as high (H), medium (M), or low (L) in priority, depending on importance for student learning or student experience. Observations related to each QI can be grouped and presented by QC. Accompanying RI indicate either that the current practice (PA=positive attribute) should be continued or modifications should be considered. For the institutional QA review, the following recommendations have been found applicable based on the foregoing qualitative evaluative metrics:

RECOMMENDATIONS

| LEV* | DESCRIPTION |
|---|---|
| SM | Clarify Placement tools used and/or methods |
| | of placing students specific programs. |
| SH | Consider a minimum English level |
| | requirement for entrance. |
| SM | Define life skills that should be included in |
| | the curriculum and incorporate them during |
| | the next curriculum review. |

As can be seen from the institutional QA review example, the recommendations are based on qualitative metrics that encompass a holistic QA review process covering the product or service under review as well as the supporting programs, courses, services, and processes.

Using this methodology, a formal report can be generated outlining a summary of key positive attributes, followed by evidenced-based observations and prioritized recommendations based on the QCs and QIs. Observations can result in recommendations either for continuance or modification of current practice. Recommendations for continuance are considered positive attributes of the institution.

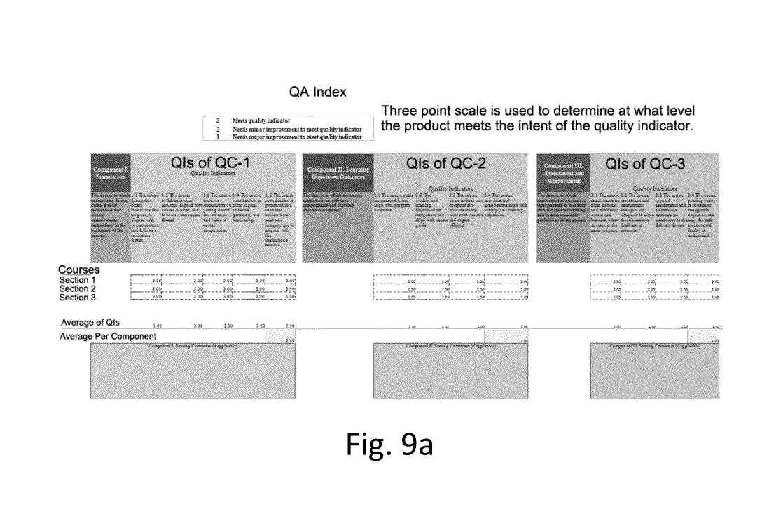

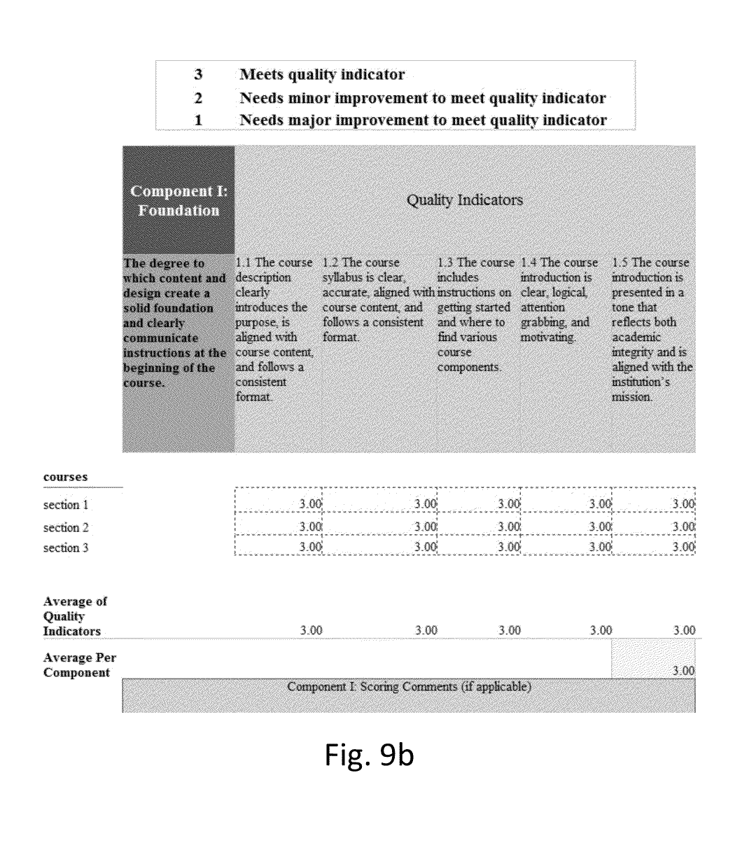

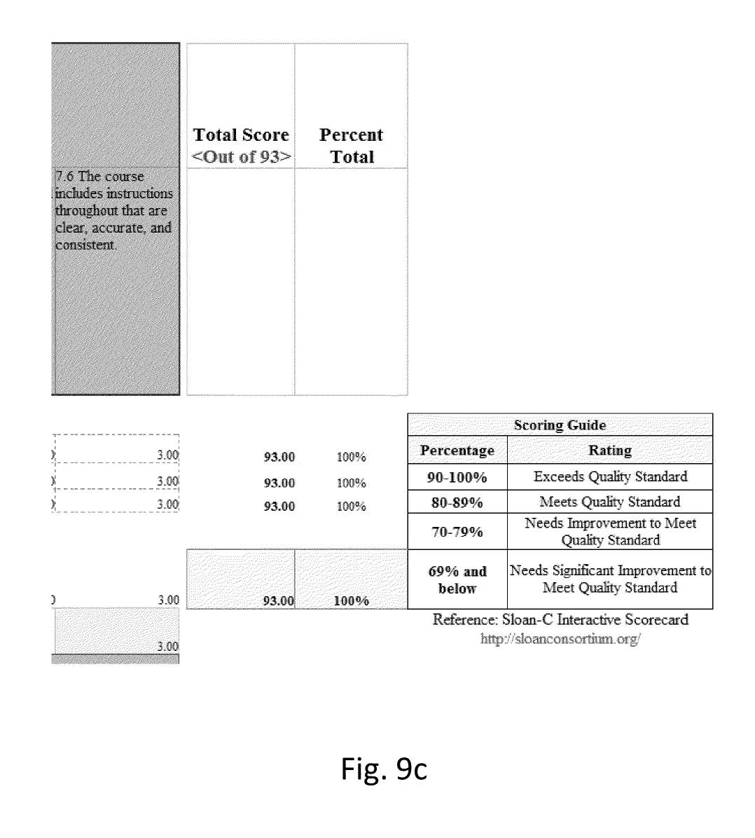

FIG. 9a shows an embodiment of the interface by which QA reviewers apply quantitative ratings to the QIs. In one example, QA criteria for assigning levels (3-1) for the QIs are as follows:
3—Meets QI
2—Needs minor improvement to meet QI
1—Needs major improvement to meet QI

FIG. 9b-9c shows a QAI module that calculates scores for each QI in the QA framework based on scores entered by QA reviewers. In one embodiment, the QAI module uses a web-based centralized content storage database and includes automated processes that apply algorithms for data input, analysis, and data output. One such QAI module can be implemented in Microsoft Excel. As can be seen, the QAI module contains the QI for QC-1 from the QA course framework. The data in the QA Workbook are used to calculate at what level the product or service meets the intent of the QI.

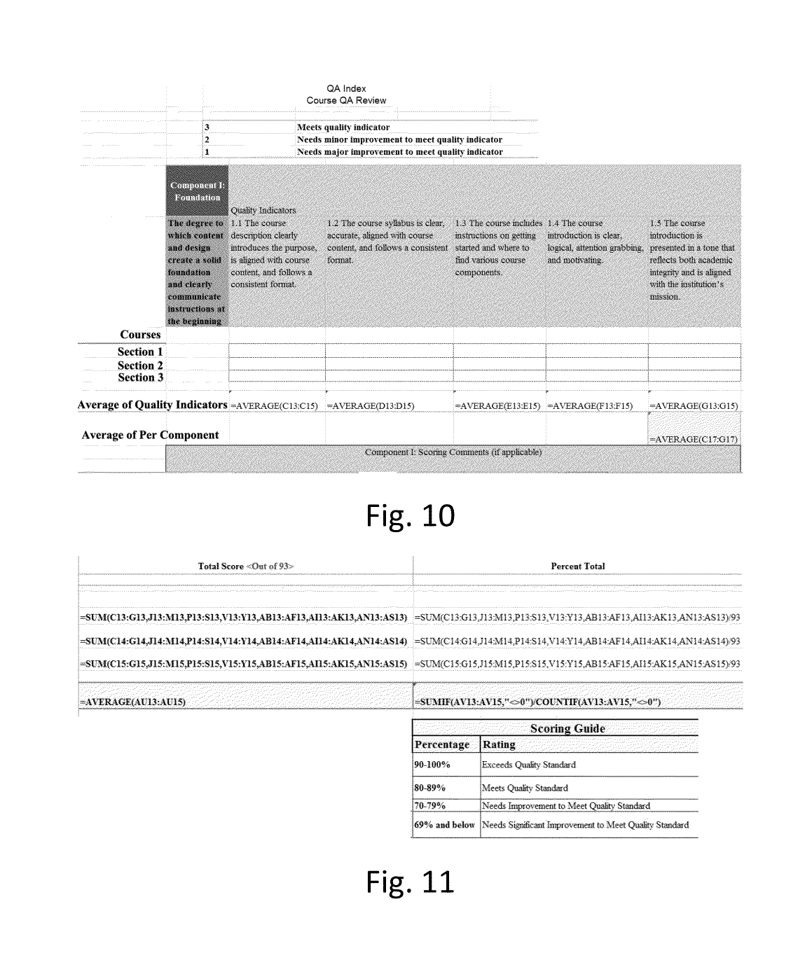

FIGS. 10-11 shows calculation functions of the QAI module. Such calculation functions allow for comparison of scores for various uses of the same product or service, or comparison of scores from multiple reviewers for QIs associated with QCs. Data are input into the QAI module, which auto-calculates scores to determine if product or service meets quality standards. As such, the QAI module is a mechanism to assign scores to each QI in the QA framework. The QA reviewer inputs the data into the QAI module, and then the average score per QI is automatically calculated by the QAI module.

The QAI module use calculation formulas and automatically calculates:
Average rating per QI
Average rating per QC
Average rating of all reviews
A total score per review
A percent total

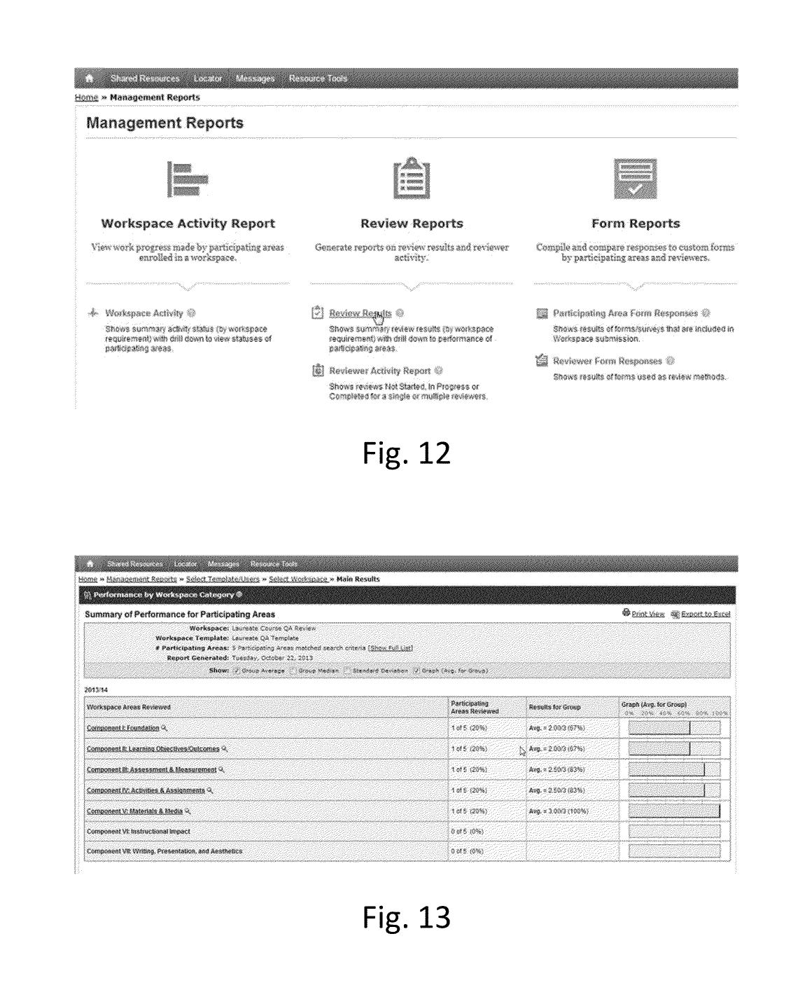

FIG. 12 shows an example of a reporting web page interface presented to user via the QAS 100 of FIG. 1. FIG. 13 is an interface showing sample summary of QA rating performance The QA report is the method of sharing the findings with stakeholders giving them an opportunity to look at QIs across institutions, programs, courses, services, and other specialized areas, such as a policy, procedure, or practice scored and determine themes. Aggregate data can be analyzed to determine how many QIs are at level 3, level 2, level 1, and tracks quality and improvement over time. The QA reviewer uses quantitative and qualitative data from observations and evidence to determine at what level the product meets the intent of the QI and assigns a 3, 2, or 1.

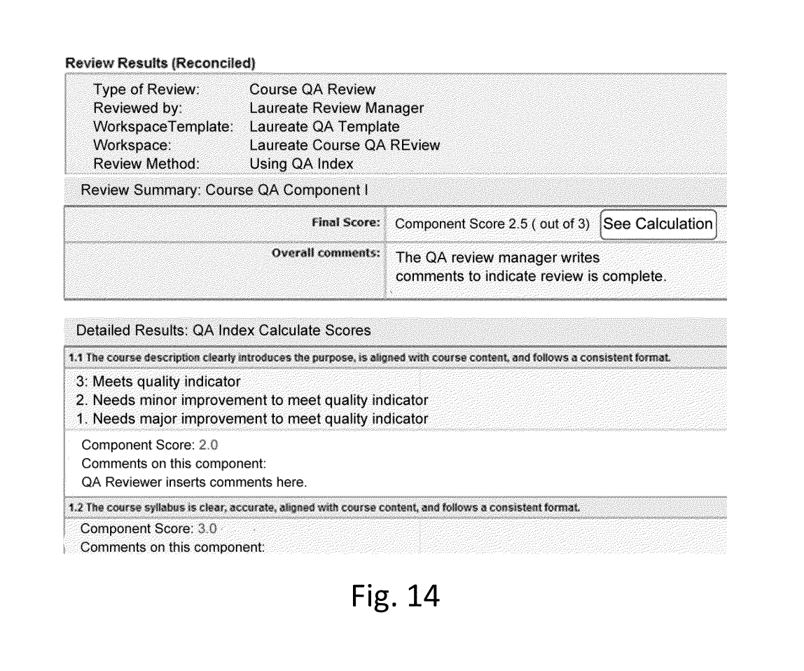

When the QA reviewers align or otherwise correlate observations and recommendations with the QIs in the QA framework, the information is integrated into a report and the QA reviewer can submit the report for review by a QA review manager. FIG. 14 shows an interface for presenting QA review results with scores and comments from the QA reviewer and QA review manager.

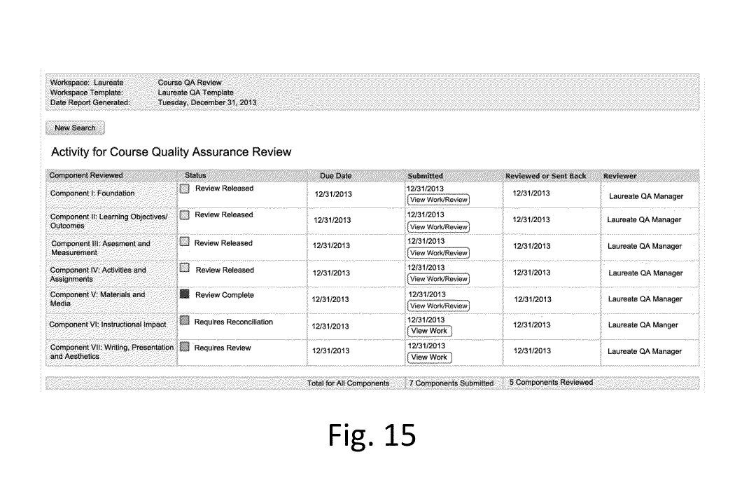

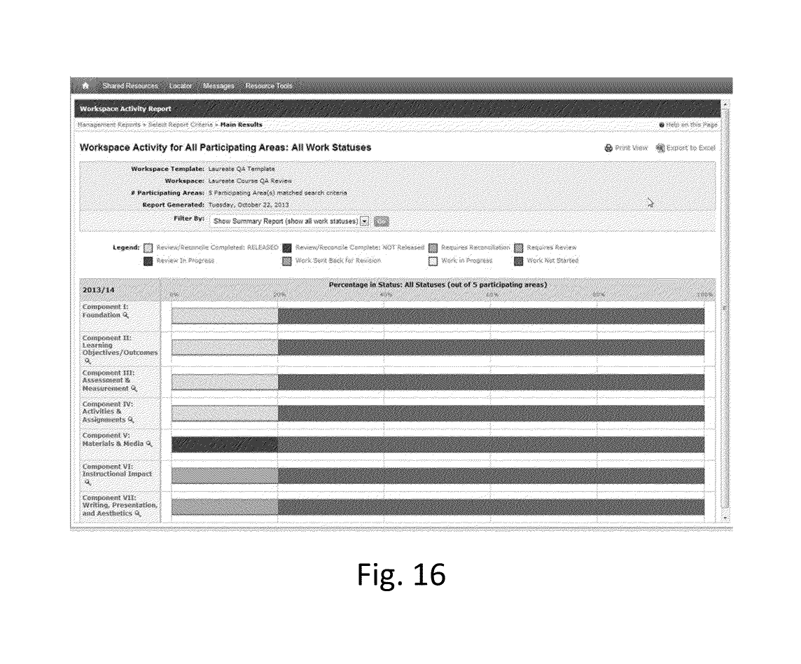

QA review statuses can be monitored in the QAS 100. Examples of statuses include: review in progress, review complete, review sent back from revision. Once the review is complete and approved, the final output, a QA report, is generated. FIG. 15 shows an interface presenting the status of activities for QA reviews. FIG. 16 shows the status activity for the course QA review.

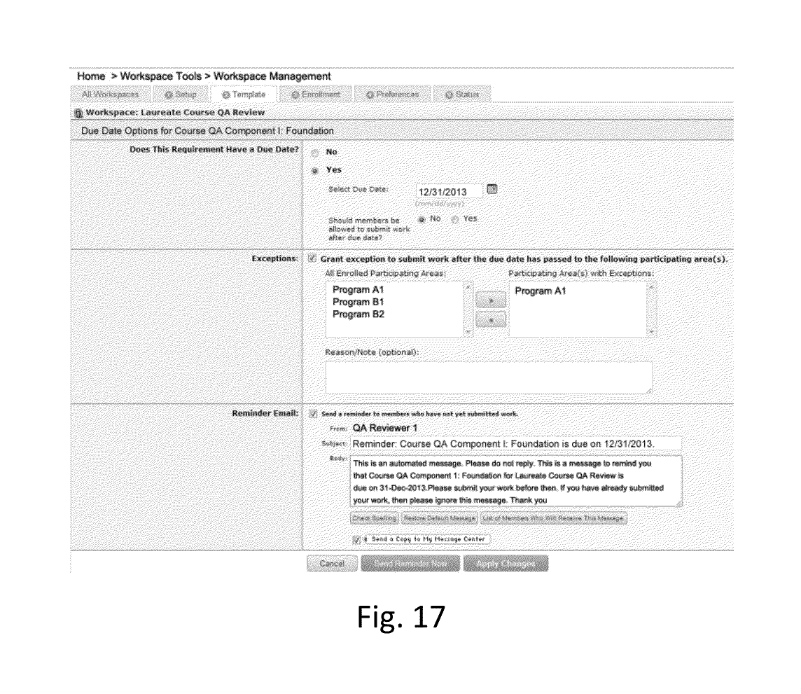

Various templates or forms can be used in the QA system of the present invention. FIG. 17 shows a notification template that allows the QA reviewer to schedule a due date for review and send notifications and reminders to participants, such as the QA review manager.

From the forgoing it would be appreciated that the QA system described above comprises a comprehensive process of evaluating and assessing the extent to which an organization and individual institutions deliver products, programs, practices, and services that demonstrate a commitment to student success and a return on investment in accordance with specified expectations. The system and method of the present invention can be used to fulfill a stated mission in consideration of regulatory mandates and accepted standards that demonstrate a student-centered environment.

What is claimed is:

1. A method for quality assurance (QA) of educational institutions, programs, courses, services, and processes comprising:
storing a QA framework associated with an educational QA review in a database, said QA framework comprising one or more Quality Components (QCs), wherein each QC is associated with one or more Quality Indicators (QI), wherein each QI is defined as a statement related to an educational quality attribute; and
presenting a QI evaluation template to one or more QA reviewers over a network for evaluating each QI, wherein the QI evaluation template is used by the one or more QA reviewers for entry of one or more Observation Information (OI) for a QI under evaluation and associating each OI with respective evidence information and recommendation information (RI); and prioritizing RI based on one or more evaluative metrics.

2. The method of claim 1, wherein the evidence information associated with each OI is associated with one or more files, said one or more files being linked to the QI under evaluation via a QA Workbook stored in the database.

3. The method of claim 1, wherein each QC is defined based on at least one Quality Theme associated with an educational quality attribute and at least one Quality Consideration framed as a question related to the at least one Quality Theme.

4. The method of claim 1, further comprising presenting a QI tasking diagram to the one or more QA reviewers specifying actions for evaluation of each QI.

5. The method of claim 1, wherein the one or more evaluative metrics are at least one of qualitative or quantitative evaluative metrics.

6. The method of claim 1, wherein the one or more quantitative evaluative metrics are calculated for each QI based on scores entered by the one or more QA reviewers.

7. The method of claim 1, further comprising monitoring QA review statuses.

8. The method of claim 1, further comprising analyzing QI data for tracking quality attributes over time.

9. The method of claim 1, further comprising presenting a template that allows a QA reviewer to schedule a due date for the QA review.

10. The method of claim 1, further comprising presenting a template that allows a QA reviewer to send notifications to one or more QA participants.

11. A system for QA of educational institutions, programs, courses, services, and processes comprising:
One or more databases configured to store a QA Framework associated with an educational QA review, said QA framework comprising one or more QCs, wherein each QC is associated with one or more QI, wherein each QI is defined as a statement related to an educational quality attribute; and
a user interface configured to present a QI evaluation template to one or more QA reviewers over a network for evaluating each QI, wherein the QI evaluation template is used by the one or more QA reviewers for entry of one or more OI for a QI under evaluation and associating each OI with respective Evidence Information and Recommendation Information; wherein the Recommendation Information is prioritized based on based on one or more evaluative metrics.

12. The system of claim 11, wherein the evidence information associated with each OI is associated with one or more files, said one or more files being linked to the QI under evaluation via a QA Workbook stored in the one or more databases.

13. The system of claim 11, wherein each QC is defined based on at least one Quality Theme associated with an educational quality attribute and at least one Quality Consideration framed as a question related to the at least one Quality Theme.

14. The system of claim 11, wherein a QI tasking diagram is presented to the one or more QA reviewers specifying actions for evaluation of each QI.

15. The system of claim 11, wherein the one or more evaluative metrics are at least one of qualitative or qualitative evaluative metrics.

16. The system of claim 11, wherein the one or more quantitative evaluative metrics are calculated for each QI based on scores entered by the one or more QA reviewers.

17. The system of claim 11, further comprising a user interface for monitoring QA review statuses.

18. The system of claim 11, wherein QI data are analyzed for tracking quality attributes over time.

19. The system of claim 11, further comprising an interface for presenting a template that allows a QA reviewer to schedule a due date for the QA review.

20. The system of claim 11, further comprising an interface for presenting a template that allows a QA reviewer to send notifications to one or more QA participants.
